(19) United States
(12) Patent Application Publication
(10) Pub. No.: US 2016/0232583 A1
(43) Pub. Date: Aug. 11, 2016

(54) REVENUE OPTIMIZATION USING CUSTOMER VALUATION OF DISPLAYED CHARACTERISTICS OF A SPECIFIC RESOURCE

(71) Applicant: Leonard John Testa, Greensboro, NC (US)

(72) Inventor: Leonard John Testa, Greensboro, NC (US)

(21) Appl. No.: 15/017,353

(22) Filed: Feb. 5, 2016

Related U.S. Application Data
(60) Provisional application No. 62/112,281, filed on Feb. 5, 2015.

(51) Int. Cl. G06Q 30/02; G06Q 10/02

(52) U.S. Cl. CPC G06Q 30/0283; G06Q 10/02

(57) ABSTRACT

A method and system of optimizing a price of a semi-fungible resource such as a particular hotel room of a given hotel room block by determining a given customer's implied value of characteristics of the specific resource (e.g., specific hotel room). Characteristics of the specific resource may include the view seen from a particular hotel room or restaurant table, how much external noise a hotel room is subjected to, the walking time from a hotel room to restaurants or transportation, or proximity of a restaurant table (i.e., resource) to the kitchen or restroom. A base price of the resource is adjusted based on the determined value of the specific characteristics to the given customer.

### CROSS-REFERENCES TO RELATED APPLICATIONS

This application claims priority to U.S. Provisional Patent Application Ser. No. 62/112,281 entitled “REVENUE OPTIMIZATION USING CUSTOMER VALUATION OF DISPLAYED CHARACTERISTICS OF A SPECIFIC RESOURCE” filed on Feb. 5, 2015.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to revenue management for a resource (e.g., a hotel room). More particularly, this invention pertains to adjusting the price of a resource to maximize revenue.

In many industries, providers of products and/or services do not factor into their prices the value their customers place on specific characteristics of the resource. Examples of specific characteristics include how quiet a specific hotel room is, its convenience to elevators or stairs, or the view the customer sees from the windows of that specific hotel room. Though some hotels do broadly segment their rooms, such as by view (e.g., water view or land view), these segments fail to take in to account their customers' valuation of specific characteristics of individual rooms within each segment.

Surveys conducted after the customer has used the resource may tell their post-hoc satisfaction with the resource, but these post-hoc surveys cannot be used to adjust the price of the resource while the customer is still considering the purchase. As a result, providers are unable to accurately determine an optimum price point when offering a specific resource to a particular customer or customer segment, and therefore cannot maximize revenue.

One example where the value of specific characteristics of a resource may be a substantial source of extra revenue is in the hotel industry. Hotels often sort their rooms into broad categories or segments that either convey some general attribute about the room (e.g., “water view” and “garden view”), or implied difference in quality (e.g., “standard room” and “preferred room”). However, within these broad categories, many differences exist between individual hotel rooms, and many customers are frequently willing to pay a substantially higher price for different rooms within the same broad category.

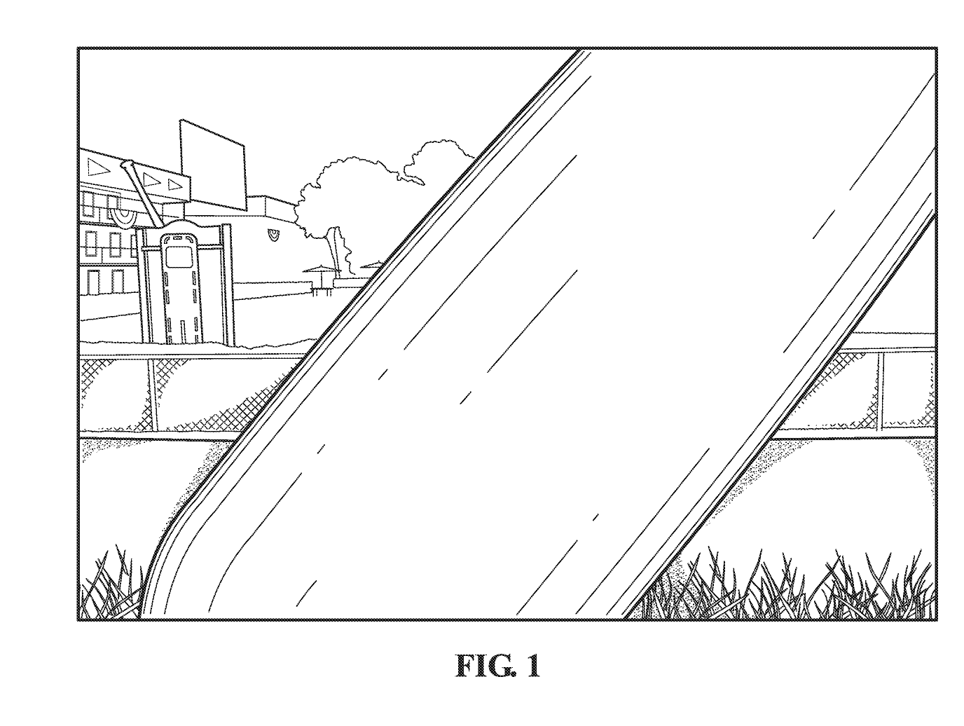

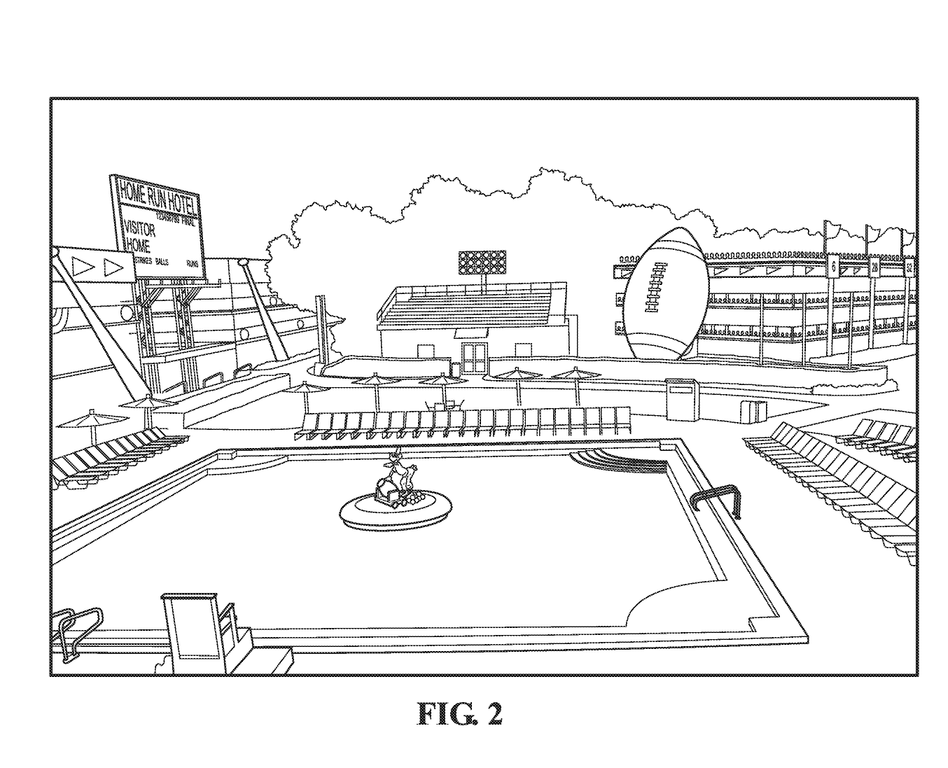

For example, FIG. 1 shows the view from hotel room 9106 at Disney's All-Star Sports Resort in Orlando, Fla. FIG. 2 shows the view from hotel room 9306 at the same resort (i.e., the room 2 floors directly above room 9106). Both hotel rooms cost the same amount, are virtually identical inside, are similarly furnished, reside in the same building at the hotel, face the same direction, and are classified by Disney into the same category or segment (“Standard”). When available at the same time, the rooms are always offered at the same rate. However, as shown in FIG. 1, the view from room 9106 is almost entirely blocked by a large piece of artwork attached to the building. Further, since room 9106 is located on the ground floor, it is exposed to substantial pedestrian traffic during the morning and evening, as customers staying in rooms on the upper floors come to the ground level and walk past room 9106 to get to the lobby, restaurants, and transportation. Finally, room 9106 is exposed to more noise from the pool area directly in front of the building, than is room 9306 two floors higher. Thus, Disney may be able to charge slightly more for room 9306 to those customers who express a preference for its view and relative quietness, rather than charging the same amount for both rooms. Conversely, Disney may be able to charge more for room 9306 to customers who prefer ground level access and do not place value on the view from the room. However, Disney cannot determine which customers place value on which aspects of the two rooms, and Disney cannot offer either room at increased rates to a customer who is willing to pay more for a particular room.

While the foregoing description applies to two specific hotel rooms at one location, the general problem is applicable to virtually any hotel in any location , and to any semi-fungible resource with secondary considerations. For example, airlines with assigned seating protocols could gain revenue by offering seats at prices customized based on a given customer's valuation of characteristics of a seat (e.g., window or aisle seat). As a further example, restaurants who accept reservations could gain revenue by offering preferred seats for a fee wherein the fee is dependent on the value that a given customer places on characteristics of a given table (e.g., table or booth, proximity to the kitchen, view, etc.).

### BRIEF SUMMARY OF THE INVENTION

Aspects of the present invention provide a system and method operable to adjust the price of a particular resource as a function of customer specific data.

In one aspect, a system and method determine whether to increase the price of a resource, prior to displaying the price to the customer, based on the direct or indirect value the customer or customer segment assigns to the resource. In one embodiment, aspects of the invention adjust the a price of a resource based on how many previous customers have viewed, “liked,” or “favorited” the resource.

In another aspect, a system and method for optimizing revenue of a given resource estimate the amount to change the resource's price, based on the direct or indirect value the customer or customer segment assigns to the resource.

In another aspect, a system manages and optimizes the price of a resource by taking in to account the value of the resource's displayed characteristics for a customer or customer segment. The system further optimizes the amount to change the resource's price for a customer or customer segment based on criteria including but not limited to information such as customer satisfaction surveys already obtained from customers who have previously purchased the resource, or information already received by the potential customer or customer segment. This optimization is performed, for example, at the time a price is requested for the potential customer so that an optimal price can be determined based on the particular characteristics of the resource that the customer or customer segment values.

Aspects of the present invention can be applied to pricing for any resource having quantifiable characteristics of value to a customer, such as direct and indirect value that are capable of being expressed, estimated, or predicted. The determined indirect value may be based on demographic characteristics, observed and/or predicted behavior, or other factors.

In one aspect, when a request for a resource (e.g., a hotel room) is received from a customer, a price for the resource is determined based on various factors. In one embodiment, the price takes indirect value (e.g., the view from a hotel room or proximity of a hotel room to an elevator) into account as one of the factors when determining the price. This indirect value can be determined in many ways. In one embodiment, the person, company or entity selling the resource (“the company”) may display the resource's characteristics on a computer network such as the World Wide Web (i.e., Internet), along with an offer to sell the resource at an unspecified price. Further, the company may implement well-known features which allow the user to save, bookmark, “like,” “favorite” or otherwise indicate that the user considers the resource worthy of future consideration. For example, the company may display the view from a specific hotel room to the customer, and allow the customer to indicate whether the view is desirable. When the customer requests the price of the specific resource (e.g., hotel room), the value of the resource's characteristics is calculated based on information acquired or derived from, or predicted by the customer or customer segment associated with the customer and the price at which the resource is offered to the customer is adjusted. Aspects of the invention thus take into account, in determining the offer price of the resource, how to adjust the price for a specific resource to a specific customer. The determination of the resource's offer price may be made at the level of the individual customer or by categorization of the customer into an appropriate customer segment, or a combination thereof. Thus, in one embodiment, in the context of a hotel operation, the number of customers and potential customers that have viewed, “bookmarked,” “favorited,” or “liked” a photograph or video of the view from a particular hotel room, may be factored in to the hotel room's price, as well as what value the particular customer is known to the system to place on the view from a room. In one embodiment, where a set of predefined prices (e.g., hotel room rack rates) exists for a resource, the predefined price may be adjusted higher if the customer expresses higher than average interest for a specific resource. Aspects of the present invention thus optimize the pricing of specific resources for specific customers in order to maximize total profit, revenue, value, and resource utilization.

In another aspect, a method of optimizing a price of a resource includes receiving, at a resource price optimizer, a request from a computing device. The request includes a customer identifier corresponding to a customer of a plurality of customers and a resource identifier corresponding to the resource. A base price corresponding to the resource identifier is retrieved from an inventory database. The inventory database includes inventory data for each resource of a plurality of resources. The inventory data includes a base price for each resource of the plurality resources. The resource is a resource of the plurality of resources such that the inventory data includes a base price for the resource. Customer relationship management data associated with the customer identifier is retrieved from a customer relationship management system database. The customer relationship management system database includes customer specific data for each customer of the plurality of customers. A second price is determined as a function of the base price and the customer relationship management data associated with the customer identifier. The determined second price is returned to the computing device.

In another aspect, a method of optimizing a price for resource includes receiving, at a resource price optimizer, a request from the computing device. The request includes a customer identifier corresponding to a customer of a plurality of customers and a resource identifier corresponding to the resource. The resource price optimizer retrieves from an inventory database a base price corresponding to the resource identifier. The inventory database includes inventory data for each resource of a plurality of resources. The inventory data includes a base price for each resource of the plurality of resources. The resource is a resource of the plurality of resources such that the inventory data includes a base price for the resource. Customer segment data is retrieved from a customer segment system as a function of the customer identifier. The customer segment system database includes customer segment data for each customer segment of a plurality of customer segments. The resource price optimizer determines a second price as a function of the base price and the retrieved customer segment data and returns the determined second price to the computing device.

In another aspect, a system is configured to optimize price of a resource. The system includes an inventory database, a customer relationship management system database, a customer segment system database, and resource price optimizer. The inventory database includes inventory data for each resource of a plurality resources. Inventory data includes a base price for each resource of the plurality of resources. The resource is a resource of the plurality resources such that the inventory data includes a base price for the resource. The customer relationship management system database includes customer specific data for each customer of a plurality of customers. The customer segment system database includes customer segment data for each customer segment of a plurality of customer segments. The resource price optimizer is configured to receive a request from a computing device. The request includes a customer identifier and a resource identifier. The customer identifier corresponds to a customer of the plurality of customers, and the resource identifier corresponds to the resource. The resource price optimizer retrieves from the inventory database base price corresponding to the resource identifier. The resource price optimizer retrieves, from the customer relationship management system database, customer relationship management data associated with the customer identifier. The resource price optimizer retrieves, from the customer segment system, customer segment data as a function of the customer relationship management data. The resource price optimizer determines a second price as a function of the base price, the customer relationship management data associated with the customer identifier, and the retrieved customer segment data. The resource price optimizer returns the determined second price to the computing device.

BRIEF DESCRIPTION OF THE SEVERAL VIEWS OF THE DRAWINGS

FIG. 1 is a photograph of the view from the main window in hotel room 9106 at Disney's All-Star Sports Resort in Orlando, Fla.

FIG. 2 is a photograph of the view from the main window in hotel room 9306 at Disney's All-Star Sports Resort in Orlando, Fla.

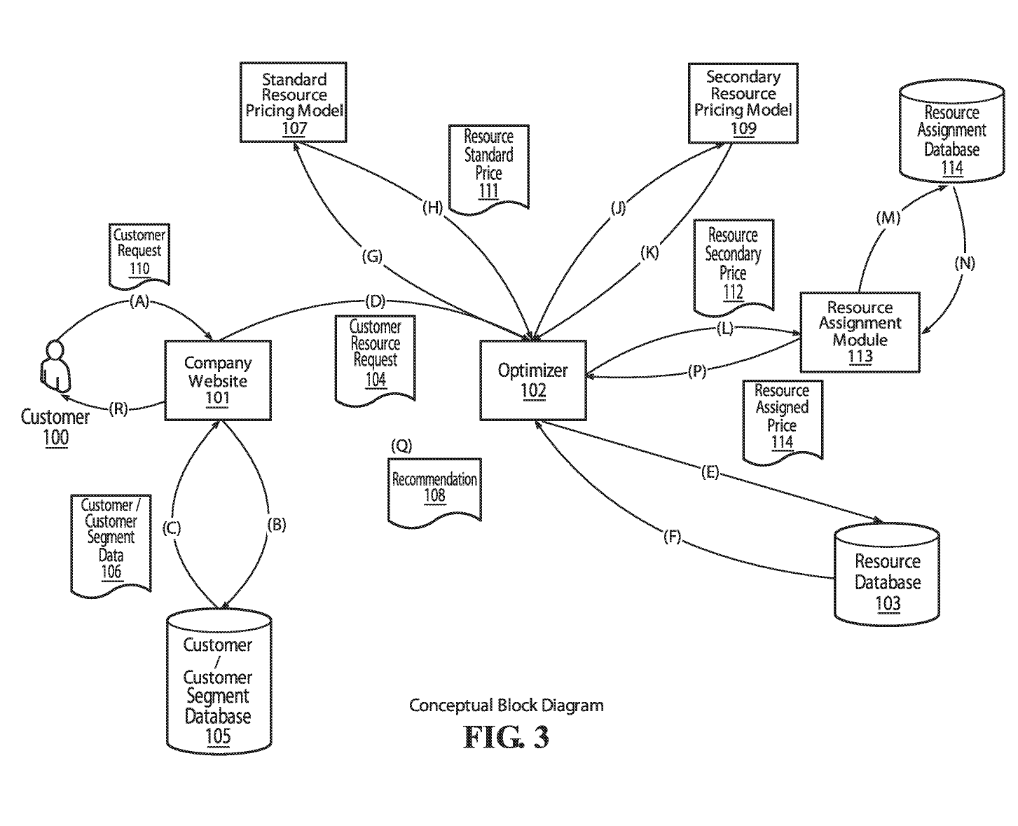

FIG. 3 is a block diagram of the functional components of one embodiment of the invention.

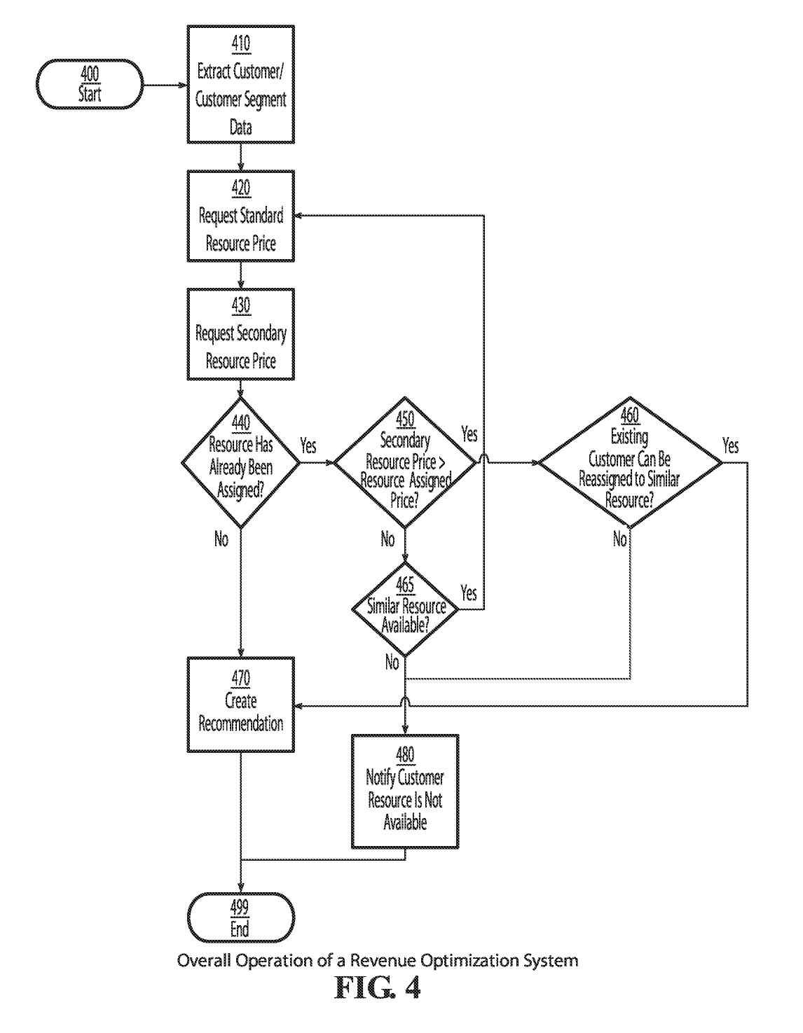

FIG. 4 is a flow chart showing overall operation of a revenue optimization system as shown in FIG. 3.

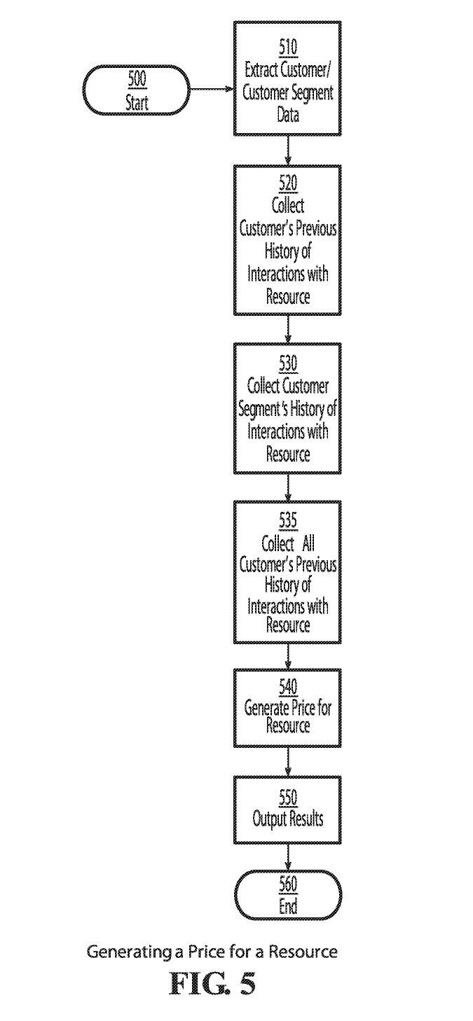

FIG. 5 is a flow chart showing a process of generating a price for a resource as shown in FIG. 3.

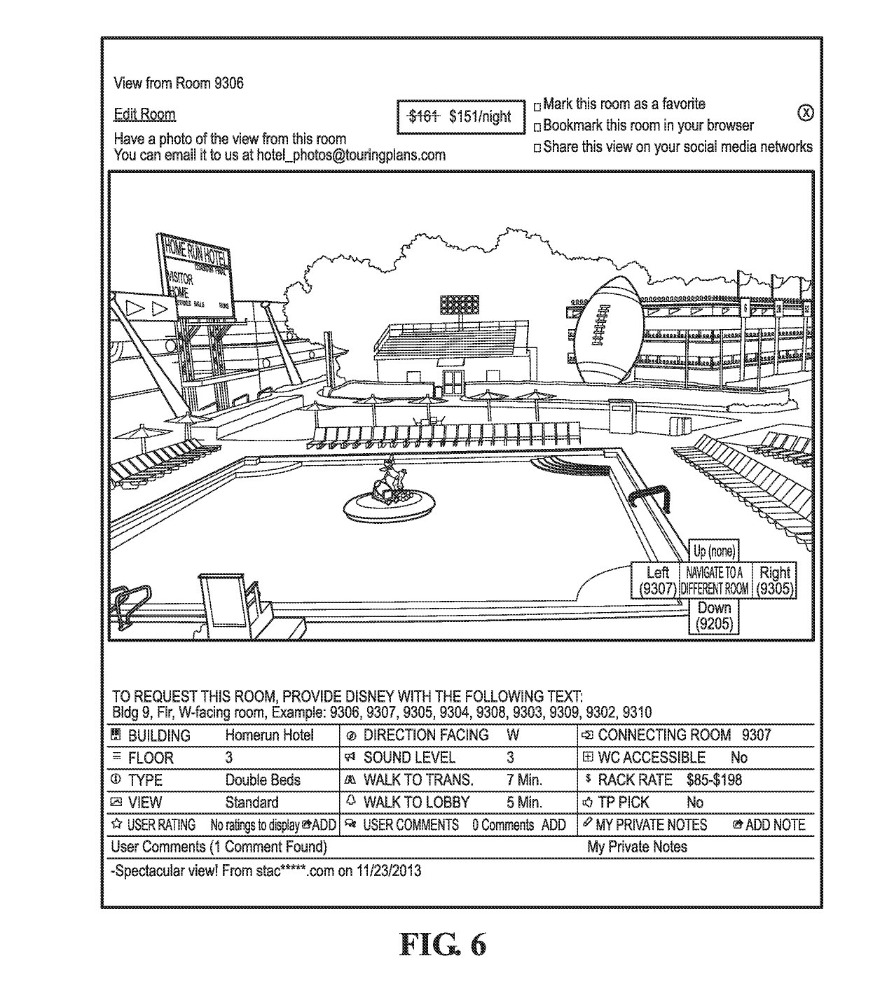

FIG. 6 is a screen capture of a resource recommendations screen for a user interface according to one embodiment of the present invention.

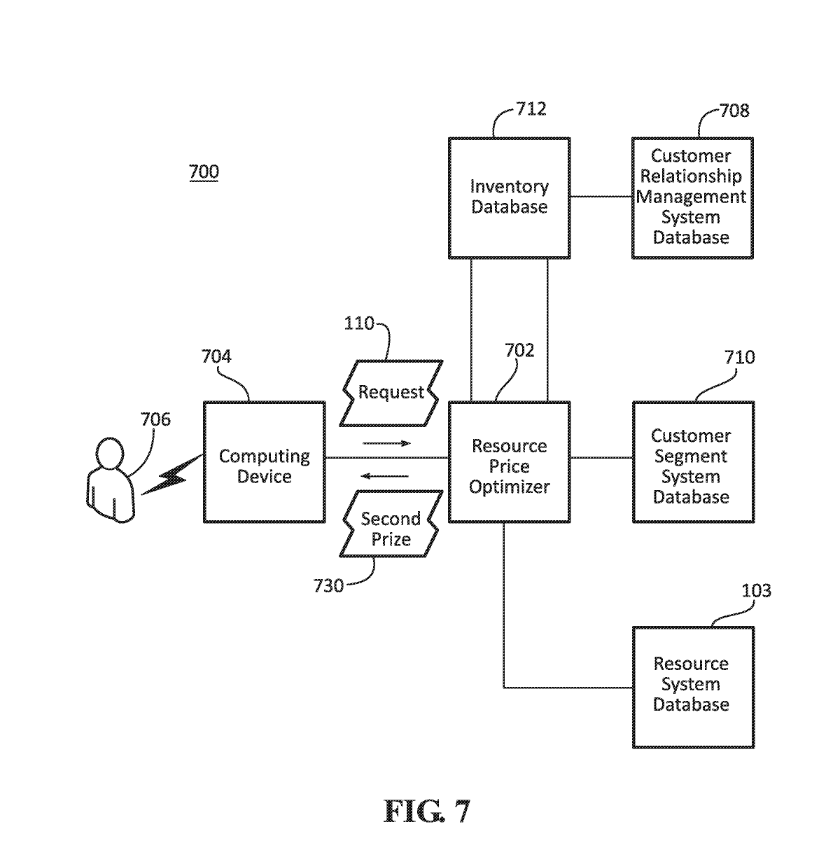

FIG. 7 is a block diagram of a system for optimizing a price of a resource according to one embodiment of the invention.

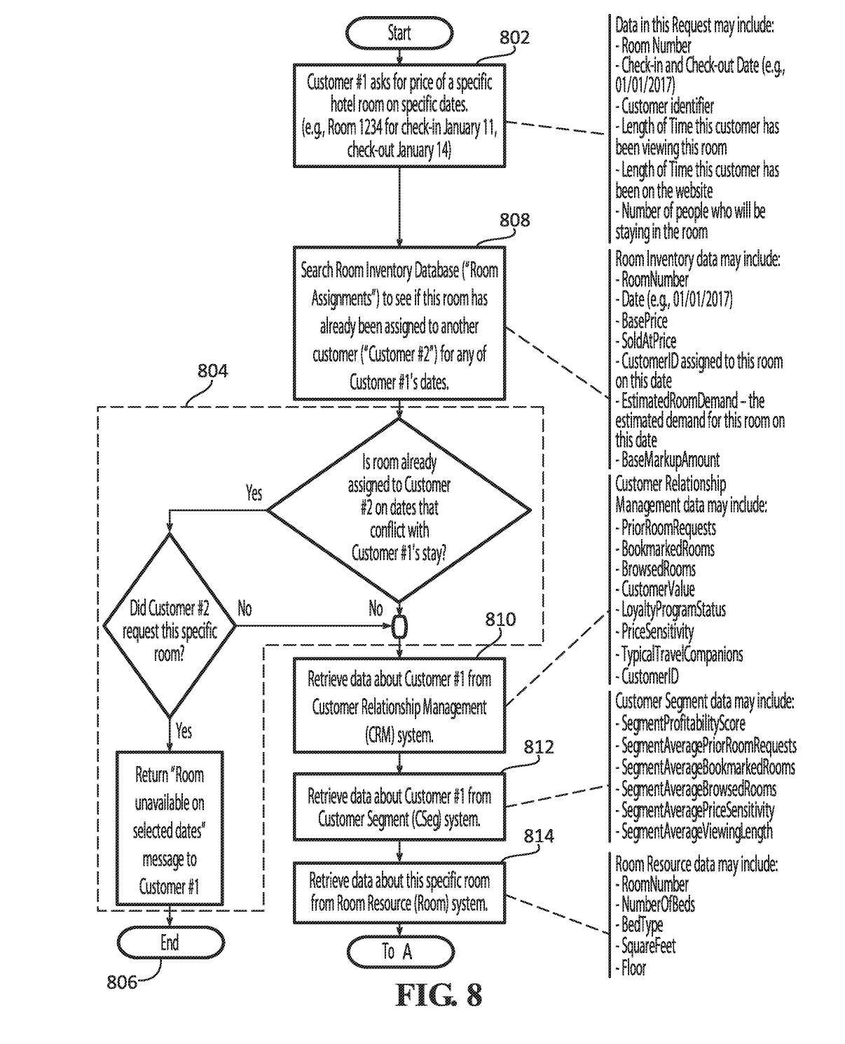

FIG. 8 is a flow chart of a system for optimizing a price of a resource as shown in FIG. 7.

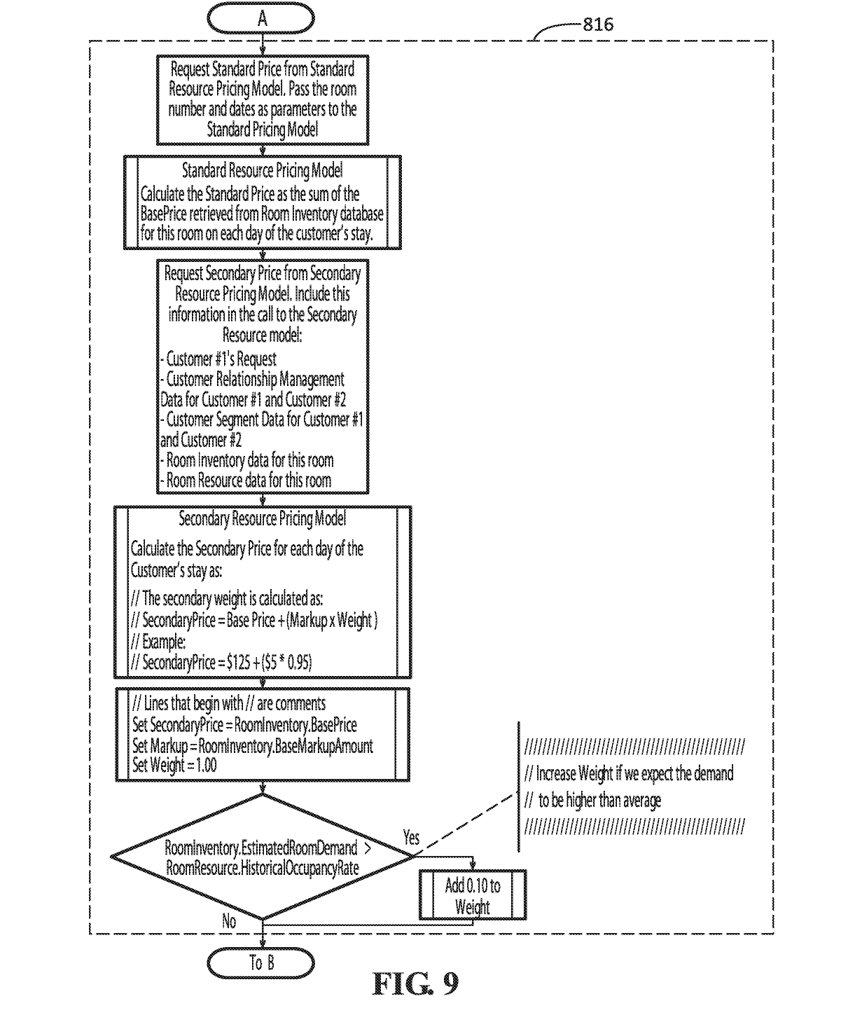

FIG. 9 is a flow chart of a system for optimizing a price of a resource as shown in FIG. 7 which continues from the flow chart of FIG. 8.

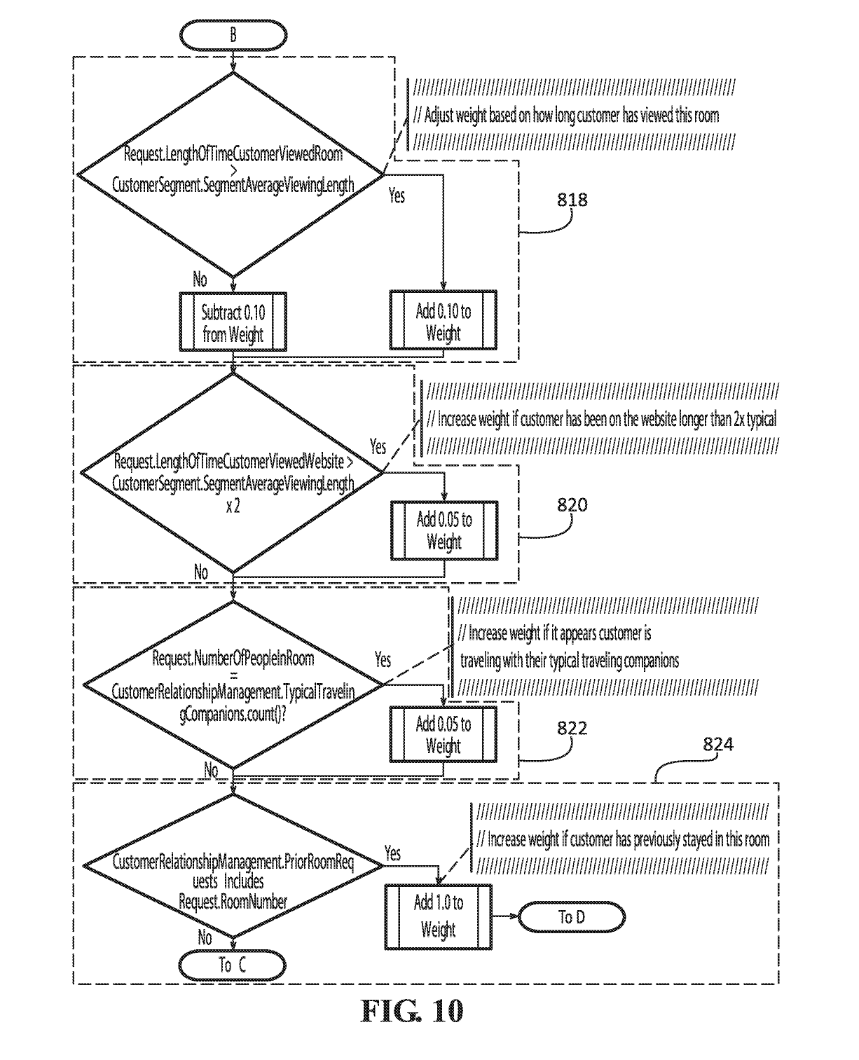

FIG. 10 is a flow chart of a system for optimizing a price of a resource as shown in FIG. 7 which continues from the flow chart of FIG. 9.

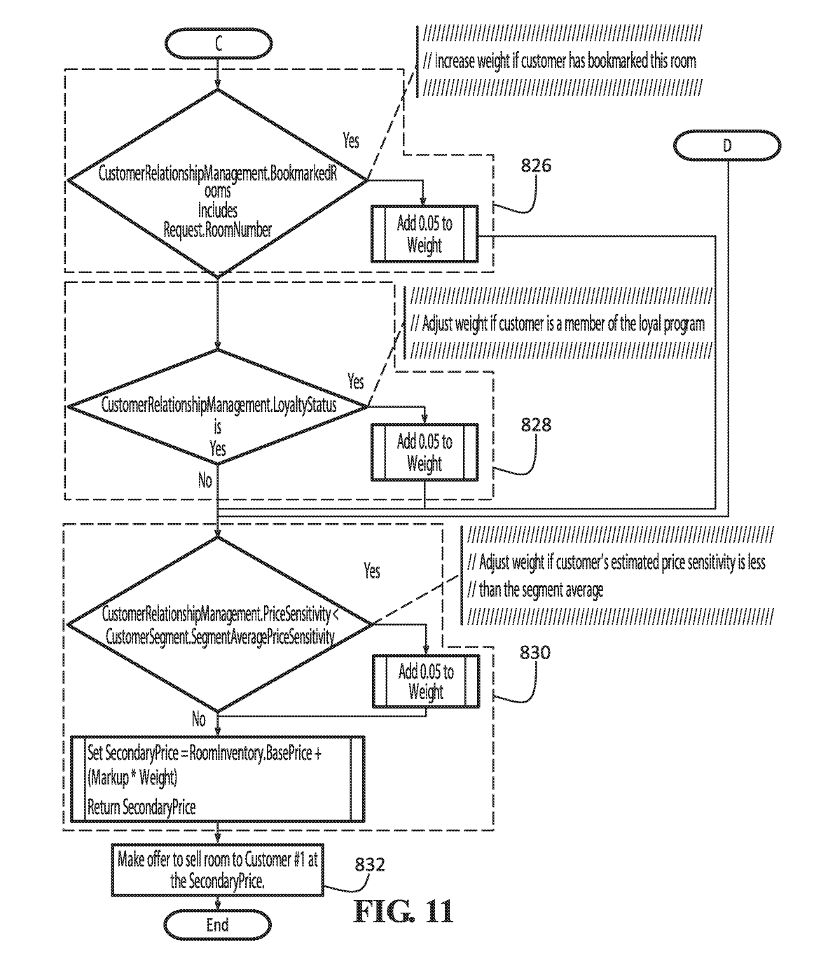

FIG. 11 is a flow chart of a system for optimizing a price of a resource as shown in FIG. 7 which continues from the flow chart of FIG. 10.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The terms “coupled” and “connected” mean at least either a direct electrical connection between the connected items or an indirect connection through one or more passive or active intermediary devices.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

### EXAMPLE 1

For the purposes of the following description of EXAMPLE 1, the following terms are defined. These definitions are not intended to limit or restrict the scope of the present invention, whose scope is defined solely the claims

Resource: A quantifiable, saleable commodity or service that is typically provided to a customer in exchange for payment. In the context of this invention, resources are assumed to be finite and discrete in quantity and/or availability. Examples: hotel rooms, air travel, cruise line travel, train travel.

Value: Quantifiable benefit to the provider of the resource, deriving directly or indirectly from a customer's consumption of the resource. Examples: revenue, profits, advertising exposure, public relations.

Customer segment: A subset of customers or potential customers, based on some common characteristic. May include zero or more customers or potential customers. Any number of customer segments may be defined for the set of all customers or potential customers.

Bookmark: A computer menu entry or icon which allows the user to go directly to something (such as an Internet site) they have seen before.

Like: A feature in communication software such as social networking services, Internet forums, news websites and blogs where the user can express that they like, enjoy, prefer, or find useful certain content.

Favorite: See “Like.”

Social media network: Various forms of electronic communication (such as Web sites, computer applications and programs) through which users share information, ideas, personal messages, and other content.

The following description illustrates the invention in the context of a system for allocating and pricing hotel rooms by taking into the customer's estimated value the room's specific characteristics, such as the specific view seen from a specific hotel room. However, the present invention can be applied to allocation and pricing for any resource with displayable characteristics of value, and is not intended to be limited to hotel room management and pricing. Accordingly, the context of the following description is not intended to limit in any way the scope of the invention, which is defined solely by the claims.

In one embodiment, the system and method takes into account multiple attributes of a resource's value, including direct and indirect value, in order to determine how to allocate and price hotel rooms for a hotel operation. The indirect value may be determined based on actual historical data, tracking or predictive modeling, estimates, demographics, or any other relevant factors. Customer segmentation may be employed in order to determine and provide such indirect value measurements.

Functional Components

Referring now to FIG. 3, there is shown a conceptual block diagram of the functional components of one embodiment of the invention. In one embodiment, various functional elements of FIG. 3 are implemented as software components running on a website.

In Step A, Customer 100 requests information via Customer Request 110 about a resource from a Company Website 101. This information may include a description or list of attributes the resource should have, and may include the dates or times on which the Customer 100 may need to use the resource.

The Company Website 101 accepts this request and in Step B queries Customer/Customer Segment Database 105 for any information already known or estimated about the Customer 100, such as demographic, previous request history, expressed or implied preferences for the resource, or other information collected directly or indirectly from or about the Customer 100. That information about the Customer 100 is returned to Company Website 101 in Step C as Customer/Customer Segment Data 106.

The Customer/Customer Segment Data 106 and Customer Request 110 are combined into Customer Resource Request 104, by Company Website 101, and the result is sent in Step D to the Optimizer 102 module to obtain an optimal price.

In Step E, Optimizer 102 queries Resource Database 103 for the resource's primary and secondary characteristics. These are returned to Optimizer 102 in Step F.

In step G, Optimizer 102 requests the resource's standard price (i.e., base price) from Standard Resource Pricing Model 107, and this standard price is returned in Step H to the Optimizer 102 as Resource Standard Price 111. In one embodiment, the standard or base price is already adjusted for expected or historical demand for rooms in the block corresponding to a room identified by the customer request 110. In another embodiment, the Optimizer 102 determines such demand pricing and adjusts the standard, base, or rack price accordingly as discussed below.

In Step J, Optimizer 102 passes the Resource Standard Price 111 and Customer Resource Request 104 to the Secondary Resource Pricing Model 109. Secondary Resource Pricing Model evaluates the information in the Customer Resource Request, including any request history, and expressed or implied preferences for the resource, and returns a Resource Secondary Price 112 to the Optimizer in Step K.

In Step L, Optimizer 102 checks Resource Assignment Module 113 to see whether the resource can be assigned to the Customer 100. Resource Assignment Module 113 checks Resource Assignment Database 114 in Step M to see whether the resource has already been assigned. That resource status is returned to the Resource Assignment Module 113 in Step N. It is contemplated that the resource assignment module 113 and resource assignment database 114 may be integral with the resource database 103 and/or standard resource pricing model 107.

If the resource has already been assigned, the price at which it has been assigned is returned to the Optimizer in Step P as Resource Assigned Price 114.

If the resource has already been assigned, the Optimizer 102 compares Resource Secondary Price 112 (i.e., second price) to Resource Assigned Price 114. If Resource Secondary Price 112 is greater than Resource Assigned Price 114, the Optimizer 102 requests Resource Assignment Module 113 to see whether the customer already assigned to the resource can be given or moved to a similar resource, so that Customer 100 can be given the current resource. If the customer already assigned to the resource specifically requested the specific resource, then the resource assignment module 113 determines that the customer already assigned to the resource cannot be moved or reassigned.

If the customer already assigned to the resource can be given, moved, assigned, or allocated to a similar resource, the Optimizer 102 creates Recommendation 108, which describes the resource's specific primary and secondary characteristics, and includes the Resource Secondary Price 112 (i.e., a second price), to Company Website 101 in Step Q. Company Website 101 presents the information in Recommendation 108 to Customer 100 in Step R.

If the customer already assigned to the resource cannot be given, moved, assigned, or allocated to a similar resource, or the Resource Secondary Price 112 (i.e., a second price) is less than or equal to Resource Assigned Price 114, the Optimizer 102 may perform a search for resources similar to the one originally requested, using Resource Database 103. For example, the hotel room next door to the one being requested may be sufficiently similar to the hotel room being requested, that the Customer 100 would find them equivalent. If the Optimizer 102 finds a similar resource, Steps G through P are repeated by the Optimizer to optimize the price of the similar resource, and the similar resource's attributes are used in Recommendation 108.

Resource Assignment

Referring now to FIG. 4, there is shown a flow chart depicting the process of assigning a resource according to one embodiment of the present invention. In one embodiment, the various functional elements of FIG. 4 are implemented as software components.

The process begins by extracting the Customer / Customer Segment data 410, then requesting the Standard Resource Price 420 from the Standard Resource Pricing Model. Once the Standard Resource Price 420 has been received, the Resource Secondary Price 430 is requested.

In Step 440, a determination is made as to whether the requested resource has already been assigned to another customer. If the answer is no, a Recommendation is created in Step 470, including the optimal recommended price for the resource. This recommendation is returned to the Customer and the process ends.

If the requested resource has already been assigned to another customer, then in Step 450 a determination is made as to whether the current Secondary Resource Price is greater than the Resource Assigned Price already quoted to the previous customer.

If the answer in 450 is yes, control flows to step 460, where it is determined whether the existing customer can be reassigned to a similar resource. In one embodiment, where the resource may be a hotel room, this step checks whether the customer currently assigned to a specific hotel room at a specific price, can be moved to a similar resource without violating the terms that the currently assigned customer has already agreed to.

For example, if the currently assigned customer had expressed no preference for any type of hotel room, and can be moved to a similar hotel room without adverse consequences, then the hotel management can increase their revenue by making that move and assigning the hotel room to the customer willing to pay more for it.

However, if it is determined in Step 450 that the currently assigned customer cannot be re-assigned to another resource, Step 465 checks whether any similar resources can be found that match or nearly match the characteristics of the original resource. In one embodiment, where the resource is a hotel room, this step may search for alternate hotel rooms that are identical or very similar to the hotel room originally requested. For example, another hotel room immediately adjacent to the original hotel room may offer a view that is acceptably similar to the original hotel room.

If Step 465 determines that a similar resource is available, control is passed back to Step 420 to determine the standard and secondary prices for the similar resource, and the process continues as before with this similar resource.

If Step 465 determines that no similar resource is available, Step 480 notifies the customer that no resource is available. The customer or the website may restart the process by offering a resource similar to the one originally displayed at the beginning of the process.

Resource Pricing

Referring now to FIG. 5, there is shown a flow chart depicting the process of creating a price for a resource according to one embodiment of the present invention. In one embodiment, the various functional elements of FIG. 5 are implemented as software components running on a conventional company website, as is known in the art.

The process begins with Step 510 by extracting the Customer/Customer Segment and Resource Data sent from the Optimizer, including the standard price of the resource.

In Step 520, the system collects the Customer's previous history of interactions with the resource. In one embodiment, where the resource is a hotel room, examples of the Customer's interactions with the resource may include metrics such as (but not limited to):
the number of times the Customer has viewed the resource on the Company Website;
the length of time the Customer spent viewing the resource on the Company Website; or
the type and number of times the Customer has “liked”, “favorited”, “bookmarked” or otherwise indicated a preference for the resource, where “liked”, “favorited”, and “bookmarked” are as known in the art; or
any previous feedback, either direct or indirect, the Customer may have provided about a previous use of or interaction with this specific resource, or similar resources, including public or private comments and/or notes.

In Step 530, the system collects the Customer Segment's previous history of interactions with the resource. In one embodiment, where the Customer is either known to be or is assumed to be female, the parent of small children, living in the southeastern United States, an example of a Customer Segment may be “Southeast Mothers of Small Children.” The system collects either individual or aggregate data on the Customer Segment's interactions with the resource. In one embodiment, where the resource is a hotel room, examples of the Customer's interactions with the resource may include metrics such as (but not limited to):
the number of times the Customer Segment has viewed the resource on the Company Website;
the length of time the Customer Segment spent viewing the resource on the Company Website;
the number of times the Customer Segment has “liked”, “favorited”, “bookmarked” or otherwise indicated a preference for the resource, where “liked”, “favorited”, and “bookmarked” are as known in the art; or
any previous feedback, either direct or indirect, the Customer Segment may have provided about a previous use of or interaction with this specific resource, or similar resources.
In Step 535, the system collects the history of all previous interactions with the resource. This history may be either individual, aggregate, or summary data of all customers' previous interactions with the resource. In one embodiment, where the resource is a hotel room, examples of all customer interactions may be:
the average number of times each previous customer has viewed the resource on the Company Website;
the average length of time each previous customer has spent viewing the resource on the Company Website;
the average number of times each previous customer has “liked”, “favorited”, “bookmarked” or otherwise indicated a preference for the resource, where “liked”, “favorited”, and “bookmarked” are as known in the art; and
the average previous feedback, either direct or indirect, that previous customers may have provided about a past use of or interaction with this specific resource, or similar resources.

In Step 540, the results from Step 520 and Step 530 are compared to the results from Step 535. If the Customer or Customer Segment history from Steps 520 and 530 indicates a higher than average preference for the resource as compared to Step 535, the price of the resource may be adjusted to reflect higher (or lower) demand or preference for this specific resource by the Customer or Customer Segment. For example, if the resource is a hotel room, and the Customer or Customer Segment history indicates a higher than average preference for this specific hotel room, the nightly price of the hotel room may be incremented by $5 (or some other markup coefficient or increase) for this specific Customer or Customer Segment.

In Step 550, the price generated in Step 540 is communicated back to the Optimizer 102, and the process ends with Step 560.

Resource Recommendation Screen

FIG. 6 displays a typical Resource Recommendation Screen for one embodiment of the invention, namely a hotel website, where the resource being offered is a specific hotel room.

The resource's primary characteristics (e.g., inventory data), such as the number of beds and their size, are displayed, along with secondary characteristics (e.g., resource specific data) such as the view from that specific hotel room, its walking distance to transportation and the lobby, and other user ratings of this specific room.

The upper right corner of the screen accepts input from this user, including allowing the user to indicate this specific room is a “favorite”; to “bookmark” this room for easy, fast, future reference; and to share this specific room's view through the user's social media networks. The aggregate number of users who “favorite,” “bookmark,” or “share” this specific resource may be tracked using these inputs.

In this embodiment, the resource's price is displayed in a yellow box in the top, middle part of the screen (“$161$151/night”). The “$161” symbol may be used to indicate the typical, maximum, or otherwise inflated price of the resource, in order to contrast the recommended price (here, “$151/night”) to the Customer 100. However, the symbol need not be an actual price recommended, charged, or paid by a previous customer; it merely serves as a contrast to the recommended price.

The recommended price (“$151/night” in this embodiment) may be this resource's Standard Price (i.e., base price), or it may be the resource's Secondary Price (i.e., second price), which may be slightly higher (or lower) than the Standard Price, depending on the analysis described earlier. In either case, the Customer 100 is not informed whether the price is the Standard (i.e., base) or Secondary price (i.e., second price).

In this embodiment, the bottom part of the screen (i.e., user interface) displays public comments made about this resource by this user and other users; and any private notes made about this resource by this user. These comments are free-form text fields, which can be analyzed for expressions of customer preference, satisfaction, or desire.

From the above description, it will be apparent that the invention disclosed herein provides a novel and advantageous system and method of optimizing prices for a resource, by taking into account primary characteristics (i.e., inventory data) and secondary characteristics (i.e., resource specific data). The above-described embodiments present the invention in the context of a hotel operation in which room rates are optimized based on actual or perceived customer value of the room view. The invention may be embodied in other specific forms without departing from the spirit or scope of the invention. For example, other operational architectures, data formats, architectures, applications, user interfaces, and process flow schemes may be used. Accordingly, the disclosure of the present invention is intended to be illustrative, but not limiting, of the scope of the invention, which is set forth in the preceding claims.

### EXAMPLE 2

Referring now to FIGS. 7-11, a second embodiment of a revenue optimization or resource price optimization system 700 is shown. Although the system 700 appears to differ in architecture from the system of FIGS. 3-6, it will be appreciated that elements of the components of the system of FIGS. 3-6 can be regrouped while retaining similar overall function. For example, resource price optimizer 702 as depicted in FIG. 7 includes optimizer 102, secondary pricing model 109, resource assignment module 113, and company website 101; customer 100 is split into customer 706 and computing device 704; customer/customer segment database 105 has been split into customer relationship management system database 708 and customer segment system database 710; and inventory database 712 includes resource assignment database 114 and standard pricing model 107. It is also contemplated that resource price optimizer 702 may be integrated into the computing device 704 while the computing device 704 is associated with the customer 706 or that the resource price optimizer 702 may be integrated into the computing device 704 while the computing device 704 is associated with a travel agent or other third party who is not the customer 706 but a representative thereof. In the example of FIGS. 7-11, the resource price that is optimized is the price of a hotel room. As used with respect to FIGS. 7-11, the term resource is synonymous with room and resource identifier is synonymous with room number.

The system 700 is configured to optimize a price of a resource. The system 700 includes the inventory database 712, the customer relationship management system database 710, the customer segment system database 710, and the resource price optimizer 702. In one embodiment, the resource system database 103 is integral with the inventory database 712. The inventory database 712 includes inventory data for each resource of a plurality of resources. The inventory data includes a base price for each resource of the plurality of resources. The resource for which the price is to be optimized is a resource of the plurality of resources such that the inventory data includes a base price for the resource whose price is to be optimized. In one embodiment, the base price stored in the inventory database for each resource of the plurality of resources is adjusted as a function of actual, historical, and/or predicted demand. In one embodiment, the inventory data includes at least one of a resource identifier, a date, a base price, a sold at price, and assigned customer identifier, an estimated resource demand, or a base markup amount as shown in Table A.

TABLE A
Inventory Database Or Room Inventory Database—A database of
information about the availability and cost of specific hotel rooms
(i.e., resources) on specific days (i.e., as specific times).

| | |
|---|---|
| Room number or | The unique identifier of this hotel room |
| resource identifier | number (e.g., room 1234). In other |
| | implementations, this is the unique |
| | identifier of the resource. |
| Date | The date on which the data in this |
| | database record applies to this |
| | resource. For example, hotel may |
| | decide to have a higher base price for a |
| | hotel room on New Year's Eve than on |
| | a random Tuesday in September. |
| Base price | The default or standard cost of the |
| | resource. |
| Sold at price | The price at which the hotel room (i.e., |
| | resource) was sold to the customer |
| | represented by the customer identifier |
| | on the state. |
| Customer identifier | The identifier of the customer assigned |
| | to this hotel room on this date |
| Estimated room demand or | An estimate of the anticipated demand |
| estimated resource demand | for this room (see i.e., resource) on this |
| | date. In this implementation, it is a |
| | number between 0 corresponding to |
| | very low demand and 1 corresponding |
| | to very high demand. |
| Base markup amount or | The initial additional revenue amount |
| markup coefficient | to request for this specific resource on |
| | this date. In this implementation, the |
| | base markup amount is US $5. |

The customer relationship management system database 708 includes customer specific data for each customer of a plurality of customers. In one embodiment, the customer relationship management data includes at least one of prior resource requests, bookmarked resources, browsed resources, customer value, loyalty program status, price sensitivity, or typical number of travel companions as shown in TABLE B.

TABLE B
customer relationship management database—a database of
information about specific customers

| | |
|---|---|
| Customer ID or customer | A unique identifier for each customer |
| identifier | in the database |
| Bookmarked rooms or | A list of resources rooms this customer |
| bookmarked resources | has bookmarked, white, or favored it on |
| | this hotel's website |
| Browsed rooms or browsed | A list of rooms or resources at this hotel |
| resources | this customer has viewed on this hotel's |
| | website |
| Customer value | A number that represents the |
| | customers value to the hotel. In this |
| | implementation, customer value is |
| | based on a scale from 0 corresponding |
| | to low value to 1 corresponding to high- |
| | value. |
| Loyalty program status | A yes no field indicating whether this |
| | customer is a member of this hotel's |
| | loyalty program if such a loyalty |
| | program exists. |
| Price sensitivity | A number that represents this hotel's |
| | estimate of this customer sensitivity to |
| | prices for this hotel room. In this |
| | implementation, it is a scale from 0 |
| | corresponding to not sensitive to 1 |
| | corresponding to highly sensitive. |
| Typical travel companions | Demographic information about the |
| | typical traveling companions for this |
| | customer. In this implementation, it is |
| | stored as adult or child. |

The customer segment system database 710 includes customer segment data for each customer segment of a plurality of customer segments. In one embodiment, the customer segment data includes at least one of segment profitability score, segment average prior resource requests, segment average bookmarked resources, segment average browsed resources, segment price sensitivity, segment average resource viewing length, or segment average time on site as shown in TABLE C.

TABLE C
customer segment database—a database of information about
customer segments. In this implementation, a segment is defined as a
combination of the customer state of residence, ZIP Code, and
number of companions in the traveling party.

| | |
|---|---|
| Segment profitability score | A number that represents this hotel's |
| | estimate of this segments overall |
| | profitability. In this implementation, |
| | it is a scale from 0 corresponding to |
| | not at all profitable 21 corresponding |
| | to highly profitable. |
| Segment average prior rumor that | A number that represents the average |
| requests or segment average prior | number of times a customer in this |
| resource requests | segment makes a specific resource or |
| | room request over the customer's |
| | entire relationship with the hotel |
| Segment average bookmarked | A number that represents the average |
| rooms were segment average | number of times a customer in this |
| bookmarked resources | segment bookmarks, likes, or favorites |
| | a specific resource or room over the |
| | customer's entire relationship with |
| | the hotel. |
| Segment average browsed | A number that represents the average |
| rooms or segment average | number of times a customer in this |
| browsed resources | segment views a specific room over the |
| | customer's entire relationship with |
| | the hotel (i.e., resource provider). |
| Segment price sensitivity | A number that represents the hotel's |
| | estimate of price sensitivity for all |
| | customers in the segment. In this |
| | implementation it is a scale from 0 |
| | corresponding to not at all sensitive to |
| | 1 corresponding to highly sensitive. |
| Segment average resource | The amount of time the average |
| viewing length | customer in the segment spent looking |
| | at this specific hotel room (i.e., |
| | resource). In this implementation, it |
| | is the amount of time the average |
| | customer in the segment spent |
| | viewing the website page holding this |
| | room's specific information in their |
| | past 24 hours of interaction with the |
| | website of the hotel. |
| Segment average time on site | The amount of time the average |
| | customer in the segment spent on the |
| | hotel's website. |

The resource system database 103 includes resource specific data for each resource of the plurality of resources. In one embodiment, the resource specific data includes at least one of a number of beds, a bed type, square footage, or a floor number as shown in TABLE D. In one embodiment, the resource system database 103 is integral with the inventory database 712 such that the resource specific data is classified as inventory data.

TABLE D
room resource or resource system database—a database of
information about specific resources. In this implementation, each
entry in the database is information about one specific hotel room.

| | |
|---|---|
| Room number or resource | Uniquely identifies this resource in |
| identifier | the database. In this implementation |
| | it is the hotel room number. |
| Number of beds | The number of beds in this hotel room |
| Bed type | The kind of beds found in this hotel |
| | room. In this implementation it is a |
| | list such as king bed or queen bed. |
| Square feet | The size of the room and square feet |
| Floor | The floor number on which this hotel |
| | room is located |

Referring now to FIGS. 8-11, a method of optimizing a price of a resource includes receiving at 802 a request 110 from the computing device 704 at the resource price optimizer 702. In one embodiment, the request 110 is received at the resource price optimizer 702 via a communications network (e.g., the Internet). In one embodiment, the request 110 includes at least one of a check-in date, a checkout date, a length of time customer you'd resource, a length of time customer viewed website, or a number of people. In one embodiment, the request 110 includes at least a customer identifier corresponding to a customer 706 of a plurality of customers and a resource identifier corresponding to the resource.

TABLE E
request 110—a list of data in a request from a customer for a
specific resource. In this implementation, the resource is a
specific hotel room on a specific set of days.

| | |
|---|---|
| Room number or resource | The hotel room number (e.g., room |
| identifier | 1234) |
| Check-in date or resource | The date or time on which the |
| start time | customer will begin using the resource |
| | (e.g., check into the hotel). |
| Checkout date or resource | The date or time in which the |
| stop time | customer will cease using the resource |
| | (e.g., check out of the hotel). |
| Length of time customer | The amount of time this customer |
| viewed room or resource | spent looking at this specific hotel |
| | room. In this implementation, it is |
| | the amount of time the customer spent |
| | viewing the website page holding this |
| | rooms specific information within the |
| | past 24 hours. |
| Length of time customer | The amount of time this customer has |
| viewed website | spent on the hotel's entire website. In |
| | this implementation, it is the amount |
| | of time the customer spent viewing |
| | the hotel's website in the past 24 |
| | hours. |
| Number of people in room | The number of people that the |
| | customer says will be staying in the |
| | room on the dates or at the times |
| | requested. |
| Customer ID or customer | A unique identifier associated with |
| identifier | the customer generating the request |

At 808, the resource price optimizer 702 retrieves from the inventory database 712 a base price corresponding to the resource identifier received in the request 110. The inventory database 712 includes inventory data for each resource of a plurality resources, and the inventory data includes a base price for each resource of the plurality resources. The resource is a resource of the plurality resources such that the inventory data includes a base price for the resource.

At 804, the resource price optimizer 702 determines whether the resource (i.e., room) identified by the request 110 has already been assigned to a customer other than the customer 706. In one embodiment, the resource price optimizer 702 makes this determination by retrieving inventory data from the inventory database 712. If the resource corresponding to the resource identifier in the received request 110 is assigned to another customer who has specifically requested the resource, then the resource price optimization method ends at 806.

At 810, the resource price optimizer 702 retrieves from the customer relationship management system database 708 customer relationship management data associated with the customer identifier of the request 110. The customer relationship management system database 708 includes customer specific data for each customer of the plurality of customers.

At 812, the resource price optimizer 702 retrieves from the customer segment system database 710 customer segment data as a function of the customer relationship management data retrieved from the customer relationship management system database 708. The customer segment system database 710 includes customer segment data for each customer segment of a plurality of customer segments.

At 814, the resource price optimizer 702 retrieves from the resource system database 103 resource specific data including a number of beds, bed type, square footage, or a floor number. As discussed above, the resource specific data may be retrieved from the inventory database 712 when the resource system database 103 is merged with the inventory database 712.

Generally, the resource price optimizer 702 then determines a second price for the resource as a function of the base price, the customer relationship management data associated with the customer identifier, and the retrieved customer segment data. In one embodiment, the resource price optimizer 702 determines the second price (i.e., secondary price) by determining a weight as a function of the customer relationship management data associated with the customer identifier and the retrieved customer segment data, multiplying the determined weight by a markup coefficient to determine the price increase, and adding the price increase to the base price to determine the second price which is ultimately returned to the computing device 704 for use by the customer 706. It will be appreciated that many different weighting schemes may be used and that amounts (i.e., increases or decreases) may be simply added to or taken away from the base price as a function of the customer relationship management data and retrieved customer segment data without the need to calculate a weight to be multiplied by the markup coefficient. However, use of a markup coefficient makes the system 700 more readily adaptable to resources in different price ranges for which different sized price increases may or may not be tolerable.

In one embodiment, at 816, the base price is adjusted as a function of expected demand for the resource. At 818, a price increase is added to the base price to determine the second price by increasing the weight when the retrieved customer relationship management data includes a length of time customer viewed resource website that exceeds a segment average viewing length of the retrieved customer segment data. At 820, a price increase is added to the base price to determine the second price by increasing the weight when the retrieved customer relationship management data includes a length of time customer viewed website that is more than double a segment average time on site of the retrieved customer segment data. At 822, a price increase is added to the base price to determine the second price by increasing the weight when the request includes a number of people in room equal to a typical travel companion number of the retrieved customer relationship management data. At 824, a price increase is added to the base price to determine the second price by increasing the weight when the request includes a resource identifier matching a resource identifier in prior resource requests of the retrieved customer relationship management data. At 826, a price increase is added to the base price to determine the second price by increasing the weight when the request includes a resource identifier matching a resource identifier in bookmarked resources of the retrieved customer relationship management data. At 828, a price increase is added to the base price to determine the second price by increasing the weight when the request includes a customer identifier matching a customer identifier of a loyalty program in the customer relationship management system database 708 or the retrieved customer relationship management data includes a loyalty program status indicating that the customer identifier is enrolled in a loyalty program associated with the resource. At 830, a price increase is added to the base price to determine the second price by increasing the weight when the customer relationship management data includes a price sensitivity less than a segment price sensitivity of the retrieved customer segment data. At 832, the second price 730 (i.e., secondary price 112) is returned to the computing device 704 by the resource price optimizer 702 for use by the customer 706. As discussed above with reference to FIG. 6, the customer 706 may be offered the resource at the determined second price 730.

It will be understood by those of skill in the art that navigating between user interface views is accomplished by selecting a tab or object in a current user interface view corresponding to another user interface view, and in response to selecting the tab or object, the user interface updates with said another user interface view corresponding to the selected tab or object.

It will be understood by those of skill in the art that providing data to the system or the user interface may be accomplished by clicking (via a mouse or touchpad) on a particular object or area of an object displayed by the user interface, or by touching the displayed object in the case of a touchscreen implementation.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although embodiments of the present invention have been described in detail, it will be understood by those skilled in the art that various modifications can be made therein without departing from the spirit and scope of the invention as set forth in the appended claims.

A controller, processor, computing device, client computing device or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media. As used herein, server is not intended to refer to a single computer or computing device. In implementation, a server will generally include an edge server, a plurality of data servers, a storage database (e.g., a large scale RAID array), and various networking components. It is contemplated that these devices or functions may also be implemented in virtual machines and spread across multiple physical computing devices.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful REVENUE OPTIMIZATION USING CUSTOMER VALUATION OF DISPLAYED CHARACTERISTICS OF A SPECIFIC RESOURCE it is not intended that such references be construed as limitations upon the scope of this invention except as set forth in the following claims.

What is claimed is:

1. A method of optimizing a price of a resource, said method comprising:
receiving, at a resource price optimizer, a request from a computing device, said request comprising:
a customer identifier corresponding to a customer of a plurality of customers, and
a resource identifier corresponding to the resource;
retrieving, from an inventory database, a base price corresponding to the resource identifier, wherein:
the inventory database comprises inventory data for each resource of a plurality of resources, said inventory data comprising a base price for each resource of the plurality of resources, and
the resource is a resource of the plurality of resources such that the inventory data comprises a base price for the resource;
retrieving, from a customer relationship management system database, customer relationship management data associated with the customer identifier, wherein the customer relationship management system database comprises customer specific data for each customer of the plurality of customers;
determining a second price as a function of the base price and the customer relationship management data associated with the customer identifier; and
returning the determined second price to the computing device.

2. The method of claim 1, further comprising:
retrieving, from a customer segment system database, customer segment data as a function of the customer relationship management data, wherein the customer segment system database comprises customer segment data for each customer segment of a plurality of customer segments; wherein:
determining the second price further comprises determining the second price as a function of the base price, the customer relationship management data associated with the customer identifier, and the retrieved customer segment data.

3. The method of claim 2, wherein:
determining the second price as a function of the base price, the customer relationship management data associated with the customer identifier, and the retrieved customer segment data comprises:
determining a weight as a function of the customer relationship management data associated with the customer identifier, and the retrieved customer segment data;
multiplying the weight by a markup coefficient to determine a price increase; and
adding the price increase to the base price to determine the second price.

4. The method of claim 2, wherein:
determining the second price as a function of the base price, the customer relationship management data associated with the customer identifier, and the retrieved customer segment data comprises:
adding a price increase to the base price to determine the second price such that the second price is more than the base price when the retrieved customer relationship management data comprises a length of time customer viewed resource website exceeds a segment average viewing length of the retrieved customer segment data.

5. The method of claim 2, wherein:
determining the second price as a function of the base price, the customer relationship management data associated with the customer identifier, and the retrieved customer segment data comprises:
adding a price increase to the base price to determine the second price such that the second price is more than the base price when the retrieved customer relationship management data comprises a length of time customer viewed website is more than double a segment average time on site of the retrieved customer segment data.

6. The method of claim 2, wherein:
determining the second price as a function of the base price, the customer relationship management data associated with the customer identifier, and the retrieved customer segment data comprises:
adding a price increase to the base price to determine the second price such that the second price is more than the base price when the request comprises a number of people in room equal to a typical travel companion number of the retrieved customer relationship management data.

7. The method of claim 2, wherein:
determining the second price as a function of the base price, the customer relationship management data associated with the customer identifier, and the retrieved customer segment data comprises:
adding a price increase to the base price to determine the second price such that the second price is more than the base price when the request comprises a resource identifier matching a resource identifier in prior resource requests of the retrieved customer relationship management data.

8. The method of claim 2, wherein:
determining the second price as a function of the base price, the customer relationship management data associated with the customer identifier, and the retrieved customer segment data comprises:
adding a price increase to the base price to determine the second price such that the second price is more than the base price when the request comprises a resource identifier matching a resource identifier in bookmarked resources of the retrieved customer relationship management data.

9. The method of claim 2, wherein:
determining the second price as a function of the base price, the customer relationship management data associated with the customer identifier, and the retrieved customer segment data comprises:
adding a price increase to the base price to determine the second price such that the second price is more than the base price when:
the request comprises a customer identifier matching a customer identifier of a loyally program in the customer relationship management system database; or
the retrieved customer relationship management data comprises a loyally program status indicating that the customer identifier is enrolled in a loyally program associated with the resource.

10. The method of claim 2, wherein:
determining the second price as a function of the base price, the customer relationship management data associated with the customer identifier, and the retrieved customer segment data comprises:
adding a price increase to the base price to determine the second price such that the second price is more than the base price when the customer relationship management data comprises a price sensitivity less than a segment price sensitivity of the retrieved customer segment data.

11. The method of claim 2, wherein the request further comprises at least one of:
a resource start time;
a resource end time;
a length of time customer viewed resource;
a length of time customer viewed website; or
a number of people.

12. The method of claim 2, wherein the inventory data further comprises at least one of:
a resource identifier;
a date;
a base price;
a sold at price;
an assigned customer identifier;
an estimated resource demand;
a base markup amount;
a number of beds;
a bed type;
a square footage; or
a floor number.

13. The method of claim 2, wherein the customer relationship management data further comprises at least one of:
prior resource requests;
bookmarked resources;
browsed resources;
customer value;
loyally program status;
price sensitivity; or
typical number of travel companions.

14. The method of claim 2, wherein the customer segment data further comprises at least one of:
segment profitability score;
segment average prior resource requests;
segment average bookmarked resources;
segment average browsed resources;
segment price sensitivity;
segment average resource viewing length; or
segment average time on site.

15. A method of optimizing a price of a resource, said method comprising:
receiving, at a resource price optimizer, a request from a computing device, said request comprising:
a customer identifier corresponding to a customer of a plurality of customers, and
a resource identifier corresponding to the resource;
retrieving, from an inventory database, a base price corresponding to the resource identifier, wherein:
the inventory database comprises inventory data for each resource of a plurality of resources, said inventory data comprising a base price for each resource of the plurality of resources, and
the resource is a resource of the plurality of resources such that the inventory data comprises a base price for the resource;
retrieving, from a customer segment system, customer segment data as a function of the customer identifier, wherein the customer segment system database comprises customer segment data for each customer segment of a plurality of customer segments;
determining a second price as a function of the base price and the retrieved customer segment data; and
returning the determined second price to the computing device.

16. A system configured to optimize a price of a resource, said system comprising:
an inventory database comprising inventory data for each resource of a plurality of resources, wherein:
the inventory data comprises a base price for each resource of the plurality of resources, and
the resource is a resource of the plurality of resources and the inventory data comprises a base price for the resource;
a customer relationship management system database comprising customer specific data for each customer of a plurality of customers;
a customer segment system database comprising customer segment data for each customer segment of a plurality of customer segments;
a resource price optimizer configured to:
receive a request from a computing device, said request comprising:
a customer identifier corresponding to a customer of the plurality of customers, and
a resource identifier corresponding to the resource;
retrieve, from the inventory database, a base price corresponding to the resource identifier;
retrieve, from the customer relationship management system database, customer relationship management data associated with the customer identifier;
retrieve, from the customer segment system, customer segment data as a function of the customer relationship management data;
determine a second price as a function of the base price, the customer relationship management data associated with the customer identifier, and the retrieved customer segment data; and
return the determined second price to the computing device.

17. The system of claim 16, further comprising:
a resource system database comprising resource specific data for each resource of the plurality of resources; and wherein:
the resource price optimizer is further configured to retrieve resource specific data from the resource system database as a function of the received resource identifier; and
the resource price optimizer is further configured to determine the second price as a function of the base price, the customer relationship management data associated with the customer identifier, the retrieved customer segment data, and the retrieved resource specific data.

18. The system of claim 16, wherein:
the resource inventory database further comprises resource specific data for each resource of the plurality of resources;
the resource price optimizer is further configured to retrieve resource specific data from the inventory database as a function of the received resource identifier; and
the resource price optimizer is further configured to determine the second price as a function of the base price, the customer relationship management data associated with the customer identifier, the retrieved customer segment data, and the retrieved resource specific data.
